(19) United States
(12) Patent Application Publication
(10) Pub. No.: US 2009/0099869 A1
(43) Pub. Date: Apr. 16, 2009

(54) IDENTIFICATION OF UNDERCODED COMORBIDITIES

(75) Inventors: Robert Darin, Westford, MA (US); Richard Johannes, Newton, MA (US); Linda Hyde, Auburn, MA (US)

Correspondence Address: MCDERMOTT, WILL & EMERY, 11682 EL CAMINO REAL, SUITE 400, SAN DIEGO, CA, 92130-2047, US

(73) Assignee: CARDINAL HEALTH 303, INC., San Diego, CA (US)

(21) Appl. No.: 11/871,615

(22) Filed: Oct. 12, 2007

(51) Int. Cl. G06Q 50/00; G06Q 30/00

(52) U.S. Cl. 705/3

(57) ABSTRACT

A method for identifying under-coded comorbidities is provided. The method comprises the step of receiving a billing entry which includes a first diagnosis corresponding to a predetermined diagnostic related group. The method further comprises the step of determining whether the billing entry includes a second diagnosis corresponding to the predetermined diagnostic related group. The method further comprises the step of, if the billing entry is determined not to include the second diagnosis, reviewing laboratory information corresponding to the billing entry to determine whether the laboratory information includes test data indicating the second diagnosis. The method further comprises the step of, if the laboratory information is determined to include test data indicating the second diagnosis, generating an alert corresponding to the billing entry and the second diagnosis.

### CROSS-REFERENCE TO RELATED APPLICATION

Not applicable

### STATEMENT REGARDING FEDERALLY SPONSORED RESEARCH OR DEVELOPMENT

Not applicable.

### FIELD

Embodiments of the present invention generally relate to diagnostic coding and, in particular, relate to the identification of under-coded comorbidities.

### BACKGROUND

Diagnosis-Related Groups (“DRGs”) are used to classify hospital cases into one of approximately 500 groups expected to have similar hospital resource use. The DRG system was developed for Medicare as part of the prospective payment system. DRGs are assigned based upon a number of criteria, including any International Classification of Diseases, Clinical Modifications, 9^{th} Revision (“ICD9-CM”) diagnoses made, treatment procedures undertaken, the age and sex of a patient, and the presence of complications or comorbidities (represented by ICD9-CM codes). DRGs are used to determine the amount a reimbursement agency, such as Medicare, pays a treatment facility, such as a hospital, as patients within each category are clinically similar and are expected to use similar levels of hospital resources.

Under Medicare's prospective payment system and similar systems employed by other health care payers, hospitals submit billing entries to a reimbursement agency and are paid on a fixed schedule according to the diagnoses and procedures included in each billing entry. The hospitals receive a set amount of money for each episode of care provided to a patient, regardless of the actual amount of care used. Accordingly, it is important for hospitals to avoid under-coding on their billing entries (e.g., neglecting to include all appropriate diagnoses on a billing entry), lest the hospital fail to properly recoup appropriate reimbursement from a health care payer agency.

### SUMMARY OF THE INVENTION

Embodiments of the present invention address the foregoing problems by comparing billing data and laboratory data to identify billing entries that inadvertently excluded comorbidities and/or complications for which there is diagnostic evidence. These billing entries are flagged for review, so that the diagnostic evidence can be reviewed and, if appropriate, the billing entries can be modified to include a diagnosis of the omitted comorbidities and/or complications to ensure that the maximum reimbursement to which a treatment facility is legally entitled is sought from a reimbursement agency.

Certain embodiments provide a method for identifying under-coded comorbidities. The method comprises the step of receiving a billing entry which includes a first diagnosis corresponding to a predetermined diagnostic related group. The method further comprises the step of determining whether the billing entry includes a second diagnosis corresponding to the predetermined diagnostic related group. The method further comprises the step of, if the billing entry is determined not to include the second diagnosis, reviewing laboratory information corresponding to the billing entry to determine whether the laboratory information includes test data indicating the second diagnosis. The method further comprises the step of, if the laboratory information is determined to include test data indicating the second diagnosis, generating an alert corresponding to the billing entry and the second diagnosis.

Certain embodiments provide a machine readable medium carrying one or more sequences of instructions for identifying under-coded comorbidities. Execution of the one or more sequences of instructions by one or more processors causes the one or more processors to perform the steps of receiving a billing entry which includes a first diagnosis corresponding to a predetermined diagnostic related group and determining whether the billing entry includes a second diagnosis corresponding to the predetermined diagnostic related group. Execution of the one or more sequences of instructions by the one or more processors causes the one or more processors to further perform the step of, if the billing entry is determined not to include the second diagnosis, reviewing laboratory information corresponding to the billing entry to determine whether the laboratory information includes test data indicating the second diagnosis. Execution of the one or more sequences of instructions by the one or more processors causes the one or more processors to further perform the step of, if the laboratory information is determined to include test data indicating the second diagnosis, generating an alert corresponding to the billing entry and the second diagnosis.

Certain embodiments provide computer executable process steps for identifying under-coded comorbidities. The process steps comprise receiving a billing entry which includes a first diagnosis corresponding to a predetermined diagnostic related group and determining whether the billing entry includes a second diagnosis corresponding to the predetermined diagnostic related group. The process steps further comprise, if the billing entry is determined not to include the second diagnosis, reviewing laboratory information corresponding to the billing entry to determine whether the laboratory information includes test data indicating the second diagnosis. The process steps further comprise, if the laboratory information is determined to include test data indicating the second diagnosis, generating an alert corresponding to the billing entry and the second diagnosis.

It is to be understood that both the foregoing summary and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 is a flow chart illustrating a method for identifying under-coded comorbidities in accordance with certain embodiments of the present invention;

FIG. 2 is a flow chart illustrating a method for identifying under-coded comorbidities in accordance with certain embodiments of the present invention;

FIG. 3 is a flow chart illustrating a method for identifying under-coded comorbidities in accordance with certain embodiments of the present invention; and

FIG. 4 is a block diagram illustrating a computer system upon which certain embodiments of the present invention may be implemented.

### DETAILED DESCRIPTION

In the following detailed description, numerous specific details are set forth to provide a full understanding of the disclosed embodiments. It will be apparent, however, to one ordinarily skilled in the art that the embodiments of the present invention may be practiced without some of these specific details. In other instances, well-known structures and techniques have not been shown in detail to avoid unnecessarily obscuring the disclosure.

Many times, when patients receive treatment at a hospital or other medical treatment facility, the hospital will perform clinical tests that provide evidence of complications and/or comorbidities (“CC”) in addition to the underlying medical problem that initially brought the patient to the hospital. Nevertheless, when preparing a billing entry for submission to a reimbursement agency (e.g., an insurance company, Medicare, etc.), this clinical data is frequently overlooked, and only the most prominent medical problem or treatment rendered is included as a diagnosis in the billing entry. By overlooking this clinical data and the associated CC, the hospital is forfeiting significant reimbursements that would offset the costs of treating the CC and the original medical problem.

For example, in the following table, several DRGs are listed in which the CC of hyponatremia is frequently overlooked when preparing billing entries.

TABLE 1

| | # Cases | # Cases | Under- | |
|---|---|---|---|---|
| | w/ DRG | Under- | Coded CC | Total |
| DRG Name | and CC | Coded | Cost/ea. | $ Forfeit |
| Simple Pneumonia & | 271 | 8 | $2,100 | $16,800 |
| Pleurisy Age >17 | | | | |
| Major Cardiovascular | 42 | 2 | $7,361 | $14,722 |
| Procedures | | | | |
| Major Small & Large | 112 | 5 | $9,516 | $47,580 |
| Bowel Procedures | | | | |
| Cholecystectomy except | 17 | 1 | $6,541 | $6,541 |
| by Laparoscope w/o | | | | |
| Common Duct Exploration | | | | |
| Kidney & Urinary Tract | 113 | 6 | $1,509 | $9,504 |
| Infections Age >17 | | | | |
| Totals | 555 | 22 | | $94,697 |

As can be seen with reference to Table 1, the cost of under-coding hyponatremia varies depending upon the DRG of the principal diagnosis. For example, neglecting to include the diagnosis of hyponatremia with a diagnosis of a kidney & urinary tract infection causes the hospital to forfeit only $1,509, while neglecting to include the diagnosis of hyponatremia with a billing entry including a major small & large bowel procedure causes the hospital to forfeit $9,516. Overall, neglecting to include this CC even in a small number of cases (e.g., 22 out of 555), causes the hospital to forfeit in excess of $90,000 in reimbursements to which it is entitled under Medicare's reimbursement system.

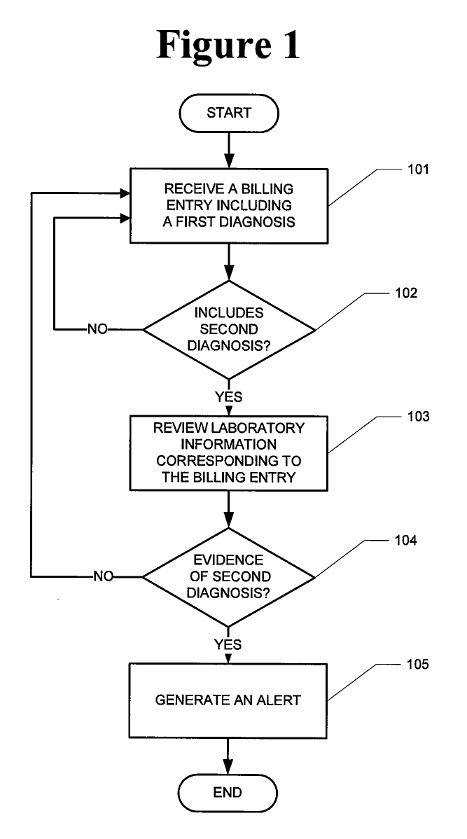

Referring now to the drawings, FIG. 1 is a flow chart illustrating a method for identifying under-coded comorbidities in accordance with one embodiment of the present invention. The method begins with step 101, in which a billing entry is received. For example, in accordance with certain aspects of the present invention in which a hospital environment prepares billing entries in a computerized format, the billing entry may be received by a computer system in the accounting department over a network connection. Alternatively, the billing entry may be received locally within same computer used to generate the billing entry (e.g., over a bus, from memory or from another storage device). The billing entry includes information about a patient, including at least one diagnosis for an illness or condition thereof. For example, the billing entry may include a diagnosis of a major cardiovascular procedure. (For the purposes of the following discussion, the term “diagnosis” is intended to include not only medical conditions diagnosed by a health care provider, but also procedures performed by a medical provider). This diagnosis is part of a predetermined diagnostic related group that is being evaluated for under-coding of comorbidities. In accordance with one aspect of the present invention, determining which DRG will be evaluated may be based on one or more of a number of factors, including frequency of under-coding diagnoses therein, potential reimbursement for under-coded comorbidities therein, etc.

The method continues in step 102, in which it is determined whether the billing entry includes a predetermined second diagnosis related to the first diagnosis. In accordance with certain aspects of the present invention, different principal diagnoses are known to be accompanied by different comorbidities with differing frequencies. Accordingly, to determine which second diagnoses to check the billing entry for, a database, table or list that correlates principal diagnoses to common comorbidities thereof may be used. For example, in the present exemplary embodiment, the principal diagnosis on the billing entry is a major cardiovascular procedure. After referencing the database, it is determined that hyponatremia is known to occur in a significant percentage of cases in which major cardiovascular procedures have been performed. Accordingly, the billing entry is reviewed to determine whether any second diagnosis is present, together with the original diagnosis of a major cardiovascular procedure, which would qualify for a higher reimbursement DRG, such as, for example, hyponatremia. If the billing entry is determined to already include such a second diagnosis, then the method moves on to the next billing entry for review (i.e., in the present exemplary embodiment, the method returns to step 101 to begin again with a new billing entry). If, however, the billing entry is determined not to include the second diagnosis, then the method proceeds to step 103.

In steps 103 and 104, laboratory information corresponding to the billing entry is reviewed to determine whether or not there is evidence to support adding the second diagnosis to the billing entry. For example, in the present exemplary embodiment, the laboratory data is reviewed to determine whether a diagnostic value, for example, the level of sodium (“Na”) in the patient, falls within a predetermined range (e.g., in the present example, below 135 mEq/mL), which might indicate that the patient was, in fact, suffering from hyponatremia. For laboratory data stored in a well-organized digital format, it is a simple matter to locate the value corresponding to the level of sodium detected in a patient's blood, and to evaluate that value (e.g., with a simple software script) to determine whether it falls within the predetermined range. If no or insufficient evidence supporting the second diagnosis is found in steps 103 and 104 (e.g., if the patient's level of sodium is determined to be ≧135 mEq/mL), then the method moves on to the next billing entry for review (i.e., in the present exemplary embodiment, the method returns to step 101 to begin again with a new billing entry). If, however, the laboratory data is determined to provided evidence supporting the addition of the second diagnosis to the billing entry (e.g., the level of sodium in the patient was <135 mEq/mL), then the method proceeds to step 105, in which an alert identifying the billing entry and the laboratory data of interest is generated.

According to certain aspects of the present invention, the range of the diagnostic value for which the laboratory data is checked depends upon the reimbursement procedures of the reimbursement agency. For example, in the foregoing exemplary embodiment, the laboratory data is checked to see if a sodium level in the patient is <135 mEq/mL, as this is the threshold used by some insurance companies for diagnosing hyponatremia. Other definitions of hyponatremia, however, may be used (e.g., a threshold of <130 mEq/mL of sodium may be used to define hyponatremia). Accordingly, as will be readily understood by those of skill in the art, the pre-determined range of the diagnostic value will depend upon not only the CC being evaluated, but on the regulations of the reimbursement agency as well.

According to certain aspects of the present invention, other CCs which may commonly be under-coded, and for which determinative laboratory data is frequently available, include congestive heart failure (indicated by abnormally high B-type natriuretic peptide), fluid/electrolyte disorders (indicated by abnormal Na, K+, Cl and/or CO₂), acute post-hemorrhagic anemia (indicated by abnormally low hemoglobin), acute myocardial infarction initial episode (indicated by abnormally high CK-MB and/or troponin), systemic inflammatory response syndrome (indicated by abnormally high white blood count, bands and/or low PCO₂), renal failure (indicated by abnormally high blood urea nitrogen and/or Cre), anemia (indicated by abnormally low iron, total iron binding capacity, hemoglobin and/or mean corpuscular hemoglobin concentration), and renal disease with renal failure (indicated by abnormally high blood urea nitrogen and/or Cre). The foregoing list is, of course, merely exemplary, and one of skill in the art will be intimately familiar with many additional CCs and the diagnostic indications associated therewith.

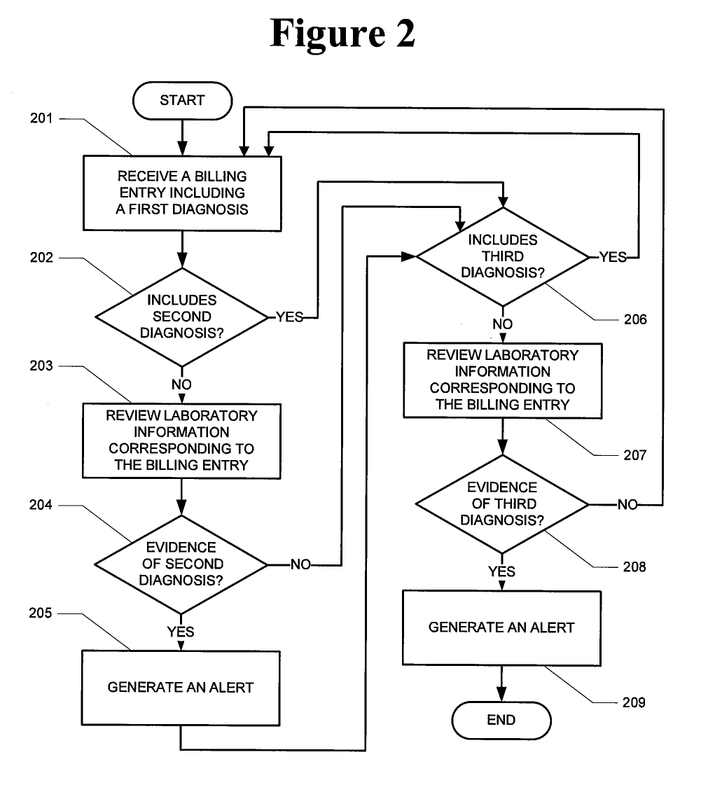

According to certain aspects of the present invention, the method for identifying under-coded comorbidities may include identifying multiple comorbidities corresponding to the principal diagnosis. For example, FIG. 2 is a flow chart illustrating a method for identifying under-coded comorbidities in accordance with certain embodiments of the present invention, in which multiple under-coded comorbidities are identified. The method begins with step 201, in which a billing entry is received. The billing entry includes information about a patient, including at least one diagnosis for an illness or condition thereof. The method continues in step 202, in which it is determined whether the billing entry includes a predetermined second diagnosis, such as anemia, related to the first diagnosis and which would place the billing entry into a higher-reimbursement DRG. If the billing entry is determined to already include the second diagnosis, then the method proceeds to step 206, in which evidence of a third diagnosis is sought in the billing entry. If, however, the billing entry is determined not to include the second diagnosis, then the method proceeds to step 203.

In steps 203 and 204, laboratory information corresponding to the billing entry is reviewed to determine whether or not there is evidence to support adding the second diagnosis to the billing entry (e.g., low iron indicating anemia). If no or insufficient evidence supporting the second diagnosis is found in steps 203 and 204, then the method moves on to step 206. If, however, the laboratory data is determined to support adding the second diagnosis to the billing entry, then the method proceeds to step 205, in which a first alert identifying the billing entry and the laboratory data of interest is generated.

After this first alert is generated, the method proceeds to step 206, in which it is determined whether the billing entry includes a predetermined third diagnosis, such as acute post-hemorrhagic anemia, related to the first diagnosis. If the billing entry is determined to already include the third diagnosis, then the method moves on to the next billing entry for review (i.e., in the present exemplary embodiment, the method returns to step 201 to begin again with a new billing entry). If, however, the billing entry is determined not to include the third diagnosis, then the method proceeds to step 207. In steps 207 and 208, laboratory information corresponding to the billing entry is reviewed to determine whether or not there is evidence to support adding the third diagnosis to the billing entry (e.g., low hemoglobin indicating acute post-hemorrhagic anemia). If no or insufficient evidence supporting the third diagnosis is found in steps 203 and 204, then the method moves on to the next billing entry for review (i.e., in the present exemplary embodiment, the method returns to step 201 to begin again with a new billing entry). If, however, the laboratory data is determined to support adding the third diagnosis to the billing entry, then the method proceeds to step 209, in which a second alert identifying the billing entry and the laboratory data of interest is generated.

In accordance with certain aspects of the present invention, the method may iteratively search for any number of additional CCs to add to a billing entry. For example, if a principal diagnosis is known to be accompanied by multiple comorbidities that would result in a higher paying DRG, the billing entry may be reviewed to determine, for each of those comorbidities, whether the comorbidity is already on the billing entry and, if not, whether it should be. According to another aspect of the present invention, the method may concurrently search for any number of additional CCs to add to a billing entry. For example, the method may first evaluate a billing entry to compile a list of any secondary diagnoses that could elevate the billing entry into a higher-reimbursement DRG, and then evaluate the laboratory data to see if any evidence is present therein for any of the secondary diagnoses on the compiled list. According to yet another aspect of the invention, the order in which the method evaluates a billing entry and laboratory data may be reversed. For example, the method may begin by evaluating laboratory data to determine what diagnoses, if any, are supported thereby. After determining a list of potential secondary diagnoses, the method may then evaluate the effect of adding any of these potential secondary diagnoses to a billing entry (e.g., to determine if doing so would elevate the billing entry to a higher-reimbursement DRG).

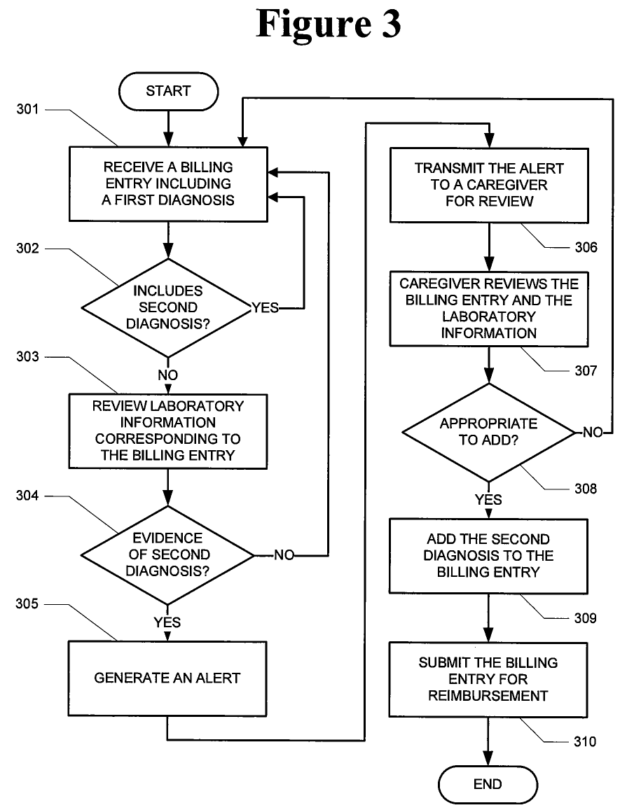

In accordance with certain aspects of the present invention, the first alert and the second alert may comprise a single alert, which may be provided to an authorized user for review in any one of a number of ways known to those of skill in the art, such as, for example, by transmission over a network, by displaying on a monitor or outputting to a printer, etc. Moreover, in certain embodiment of the present invention, a method for identifying under-coded comorbidities need not stop with the generation of an alert. For example, FIG. 3 is a flow chart illustrating a method for identifying under-coded comorbidities in accordance with one embodiment of the present invention in which the billing entry is reviewed, revised to include the comorbidity as a second diagnosis, and submitted to a reimbursement agency for reimbursement. The method begins with step 301, in which a billing entry is received. The billing entry includes information about a patient, including at least one diagnosis for an illness or condition thereof. The method continues in step 302, in which it is determined whether the billing entry includes a predetermined second diagnosis related to the first diagnosis. If the billing entry is determined to already include the second diagnosis, then the method moves on to the next billing entry for review (i.e., in the present exemplary embodiment, the method returns to step 301 to begin again with a new billing entry). If, however, the billing entry is determined not to include the second diagnosis, then the method proceeds to step 303.

In steps 303 and 304, laboratory information corresponding to the billing entry is reviewed to determine whether or not there is evidence to support adding the second diagnosis to the billing entry. If no or insufficient evidence supporting the second diagnosis is found in steps 303 and 304, then the method moves on to the next billing entry for review (i.e., in the present exemplary embodiment, the method returns to step 301 to begin again with a new billing entry). If, however, the laboratory data is determined to support adding the second diagnosis to the billing entry, then the method proceeds to step 305, in which an alert identifying the billing entry and the laboratory data of interest is generated.

In step 306, the alert is transmitted to a caregiver (e.g., a doctor, pharmacist, nurse, hospital administrator, etc.) for review. The alert identifies the billing entry and the laboratory data of interest, and may further flag the particular diagnostic value from the test data of interest, together with a brief explanation of why the test data has been identified (e.g., indicating that the sodium level is less than 135, and that it may be appropriate to add a second diagnosis of hyponatremia). In step 307, the caregiver reviews the laboratory data and the billing entry to determine whether, in fact, the addition of a second diagnosis to the billing entry is appropriate. According to one aspect of the present invention, including a layer of human oversight in the method may ensure that inappropriate over-coding does not occur (e.g., if there is an alternative explanation for the low sodium levels that may be apparent to a doctor upon reviewing the laboratory data). As shown in step 308, if the caregiver determines that it would be inappropriate to add the second diagnosis to the billing entry, the method moves on to the next billing entry for review (i.e., in the present exemplary embodiment, the method returns to step 301 to begin again with a new billing entry). If, however, the caregiver determines that it would be appropriate, then the second diagnosis is added to the billing entry in step 309. The method proceeds to step 310, in which the billing entry is submitted to a reimbursement agency (e.g., an insurance company, Medicare, etc.) for reimbursement.

According to certain embodiments of the present invention, the step of caregiver review may be excluded, if allowed by the applicable reimbursement agency, so as to entirely automate the method of revising billing entries. Such an approach may be appropriate, for example, in connection with DRGs where the comorbidities can be definitively identified from laboratory data, and the risk of misinterpretation thereof is very low. According to one aspect, the threshold of the diagnostic value in the laboratory data may be selected to exclude “close calls,” (e.g., out of an abundance of caution, only sodium levels less than 130 mEq/mL would be flagged if the layer of human review were removed from the method).

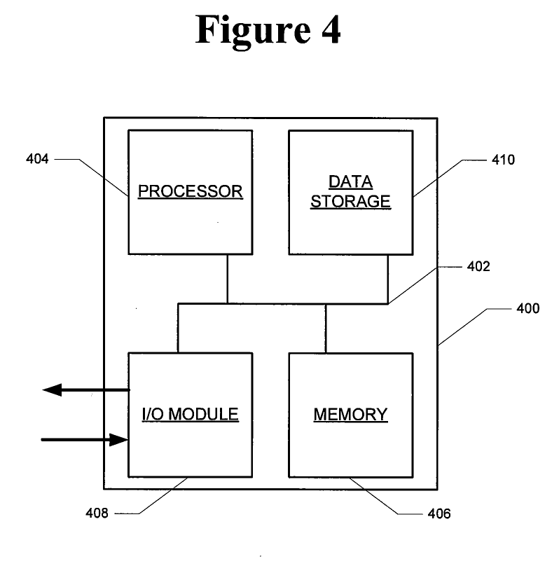

According to one aspect of the present invention, the billing entries and the laboratory data are provided in a computerized format (e.g., included in a database accessible by computer). Accordingly, the method of identifying under-coded comorbidities may be provided as computerized process steps for execution by a computer system. FIG. 4 is a block diagram that illustrates a computer system 400 upon which an embodiment of the present invention may be implemented. Computer system 400 includes a bus 402 or other communication mechanism for communicating information, and a processor 404 coupled with bus 402 for processing information. Computer system 400 also includes a memory 406, such as a random access memory (“RAM”) or other dynamic storage device, coupled to bus 402 for storing information and instructions to be executed by processor 404. Memory 406 may also be used for storing temporary variable or other intermediate information during execution of instructions to be executed by processor 404. Computer system 400 further includes a data storage device 410, such as a magnetic disk or optical disk, coupled to bus 402 for storing information and instructions.

Computer system 400 may be coupled via I/O module 408 to a display device (not illustrated), such as a cathode ray tube (“CRT”) or liquid crystal display (“LCD”) for displaying information to a computer user. An input device, such as, for example, a keyboard or a mouse may also be coupled to computer system 400 via I/O module 408 for communicating information and command selections to processor 404.

According to one embodiment of the invention, identifying under-coded comorbidities is performed by a computer system 400 in response to processor 404 executing one or more sequences of one or more instructions contained in memory 406. Such instructions may be read into memory 406 from another machine-readable medium, such as data storage device 410. Execution of the sequences of instructions contained in main memory 406 causes processor 404 to perform the process steps described herein. One or more processors in a multi-processing arrangement may also be employed to execute the sequences of instructions contained in memory 406. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing instructions to processor 404 for execution. Such a medium may take many forms, including, but not limited to, non-volatile media, volatile media, and transmission media. Non-volatile media include, for example, optical or magnetic disks, such as data storage device 410. Volatile media include dynamic memory, such as memory 406. Transmission media include coaxial cables, copper wire, and fiber optics, including the wires that comprise bus 402. Transmission media can also take the form of acoustic or light waves, such as those generated during radio frequency and infrared data communications. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, a carrier wave, or any other medium from which a computer can read.

According to certain aspects of the present invention, the method of identifying under-coded comorbidities may be performed in real or near-real time (e.g., as billing entries are generated) or retrospectively (e.g., by processing all of the billing entries generated over the last month prior to submission). In this regard, when a step of caregiver review is included in the method, the alerts generated for review by the caregiver may be stored in a document or database in, for example, data storage device 410, or may be transmitted across a network to a remote location (e.g., a separate computer terminal, a centralized database, etc.)

The description of the invention is provided to enable any person skilled in the art to practice the various embodiments described herein. While the present invention has been particularly described with reference to the various figures and embodiments, it should be understood that these are for illustration purposes only and should not be taken as limiting the scope of the invention.

There may be many other ways to implement the invention. Various functions and elements described herein may be partitioned differently from those shown without departing from the spirit and scope of the invention. Various modifications to these embodiments will be readily apparent to those skilled in the art, and generic principles defined herein may be applied to other embodiments. Thus, many changes and modifications may be made to the invention, by one having ordinary skill in the art, without departing from the spirit and scope of the invention.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the invention, and are not referred to in connection with the interpretation of the description of the invention. All structural and functional equivalents to the elements of the various embodiments described throughout this disclosure that are known or later come to be known to those of ordinary skill in the art are expressly incorporated herein by reference and intended to be encompassed by the invention. Moreover, nothing disclosed herein is intended to be dedicated to the public regardless of whether such disclosure is explicitly recited in the above description.

What is claimed is:

1. A method for identifying under-coded comorbidities, the method comprising the steps of:
receiving a billing entry, the billing entry including a first diagnosis corresponding to a predetermined diagnostic related group;
determining whether the billing entry includes a second diagnosis corresponding to the predetermined diagnostic related group;
if the billing entry is determined not to include the second diagnosis, reviewing laboratory information corresponding to the billing entry to determine whether the laboratory information includes test data indicating the second diagnosis; and
if the laboratory information is determined to include test data indicating the second diagnosis, generating an alert corresponding to the billing entry and the second diagnosis.

2. The method of claim 1, further comprising the steps of:
determining whether the billing entry includes a third diagnosis corresponding to the predetermined diagnostic related group;
if the billing entry is determined not to include the third diagnosis, reviewing laboratory information corresponding to the billing entry to determine whether the laboratory information includes test data indicating the third diagnosis; and
if the laboratory information is determined to include test data indicating the third diagnosis, generating an alert corresponding to the billing entry and the third diagnosis.

3. The method of claim 1, further comprising the step of:
transmitting the alert to a caregiver for review.

4. The method of claim 1, further comprising the step of:
a caregiver reviewing the billing entry and the laboratory information to determine whether the second diagnosis can appropriately be added to the billing entry.

5. The method of claim 4, further comprising the step of:
adding the second diagnosis to the billing entry.

6. The method of claim 5, further comprising the step of:
submitting the billing entry for reimbursement by a reimbursing entity.

7. The method of claim 1, further comprising the step of:
adding the second diagnosis to the billing entry.

8. The method of claim 1, wherein the step of reviewing laboratory information includes determining whether the test data includes a diagnostic value within a predetermined range.

9. The method of claim 1, wherein the step of receiving the billing entry occurs when the billing entry is created.

10. The method of claim 1, wherein the step of receiving the billing entry includes receiving the billing entry from a database including a plurality of billing entries.

11. The method of claim 1, wherein the second diagnosis is a complication or comorbidity that occurs concurrently with the first diagnosis with at least a predetermined frequency.

12. The method of claim 1, wherein the alert includes information corresponding to the billing entry and the laboratory information and the test data.

13. A machine readable medium carrying one or more sequences of instructions for identifying under-coded comorbidities, wherein execution of the one or more sequences of instructions by one or more processors causes the one or more processors to perform the steps of:
receiving a billing entry, the billing entry including a first diagnosis corresponding to a predetermined diagnostic related group;
determining whether the billing entry includes a second diagnosis corresponding to the predetermined diagnostic related group;
if the billing entry is determined not to include the second diagnosis, reviewing laboratory information corresponding to the billing entry to determine whether the laboratory information includes test data indicating the second diagnosis; and
if the laboratory information is determined to include test data indicating the second diagnosis, generating an alert corresponding to the billing entry and to the second diagnosis.

14. The machine readable medium of claim 13, wherein execution of the one or more sequences of instructions by the one or more processors causes the one or more processors to further perform the steps of:
determining whether the billing entry includes a third diagnosis corresponding to the predetermined diagnostic related group;
if the billing entry is determined not to include the third diagnosis, reviewing laboratory information corresponding to the billing entry to determine whether the laboratory information includes test data indicating the third diagnosis; and
if the laboratory information is determined to include test data indicating the third diagnosis, generating an alert corresponding to the billing entry and the third diagnosis.

15. The machine readable medium of claim 13, wherein execution of the one or more sequences of instructions by the one or more processors causes the one or more processors to further perform the step of:
transmitting the alert to a caregiver for review.

16. The machine readable medium of claim 13, wherein execution of the one or more sequences of instructions by the one or more processors causes the one or more processors to further perform the step of:
adding the second diagnosis to the billing entry.

17. The machine readable medium of claim 16, wherein execution of the one or more sequences of instructions by the one or more processors causes the one or more processors to further perform the step of:
submitting the billing entry for reimbursement by a reimbursing entity.

18. The machine readable medium of claim 13, wherein the step of reviewing laboratory information includes determining whether the test data includes a diagnostic value within a predetermined range.

19. The machine readable medium of claim 13, wherein the step of receiving the billing entry occurs when the billing entry is created.

20. The machine readable medium of claim 13, wherein the step of receiving the billing entry includes receiving the billing entry from a database including a plurality of billing entries.

21. The machine readable medium of claim 13, wherein the second diagnosis is a complication or comorbidity that occurs concurrently with the first diagnosis with at least a predetermined frequency.

22. The machine readable medium of claim 13, wherein the alert includes information corresponding to the billing entry and the laboratory information and the test data.

23. Computer executable process steps for identifying under-coded comorbidities, the process steps comprising:
receiving a billing entry, the billing entry including a first diagnosis corresponding to a predetermined diagnostic related group;
determining whether the billing entry includes a second diagnosis corresponding to the predetermined diagnostic related group;
if the billing entry is determined not to include the second diagnosis, reviewing laboratory information corresponding to the billing entry to determine whether the laboratory information includes test data indicating the second diagnosis; and
if the laboratory information is determined to include test data indicating the second diagnosis, generating an alert corresponding to the billing entry and the second diagnosis.
